(19) United States
(12) Patent Application Publication
(10) Pub. No.: US 2014/0310123 A1
(43) Pub. Date: Oct. 16, 2014

(54) CHECK-OUT PATH FOR MULTIPLE RECIPIENTS

(71) Applicant: Shutterfly, Inc., Redwood City, CA (US)

(72) Inventors: George Olsen, Menlo Park, CA (US); Sara Stearns, Oakland, CA (US); Ross Williams, San Mateo, CA (US)

(73) Assignee: Shutterfly, Inc., Redwood City, CA (US)

(21) Appl. No.: 14/244,070

(22) Filed: Apr. 3, 2014

Related U.S. Application Data
(60) Provisional application No. 61/812,531, filed on Apr. 16, 2013.

(51) Int. Cl. G06Q 30/06

(52) U.S. Cl. CPC G06Q 30/0633
USPC 705/26.5; 705/26.8

(57) ABSTRACT

A computer-implemented method is disclosed to enable a user to order multiple product items for multiple recipients.

### TECHNICAL FIELD

This application relates to electronic commerce, and more specifically, to flexible check-out paths that allow users form orders multiple products for multiple recipients over a computer network.

### BACKGROUND OF THE INVENTION

Electronic commerce requires convenient ways for users to design, select, and pay for products on a computer user interface. Examples of user interfaces include a web browser and a mobile application.

Attempts to simplify the checkout process include, for example, the single click check out developed by Amazon, Inc. Although single-click check can be effective for ordering products for a single recipient, check-out paths still involve multiple steps and multiple web pages for network based services that provide different types of products to multiple recipients in one order.

There is therefore a need for more convenient methods to allow users to order products from network based services for multiple recipients.

### SUMMARY OF THE INVENTION

The present application discloses a simple workflow to allow users to order products from network based services for multiple recipients. A user can conveniently select different products for different recipients without leaving a same page in a user interface. The disclosed method is compatible with web, mobile app, and other types of user interfaces for ordering products over wired or wireless networks.

In a general aspect, the present invention relates to a computer-implemented method for a user to order multiple product items for multiple recipients. The method includes: allowing a user, by a computer network system, to select multiple product items to be placed in a single order at a user interface, wherein the multiple product items comprises a first product item and a second product item; displaying the multiple product items on a page at the user interface; displaying a first selection popover next to the first product item on the same page at the user interface, wherein the first selection popover includes names of a plurality of recipients; allowing the user to select, in the first selection popover, one or more of the plurality of recipients to receive the first product item; displaying a second selection popover next to the second product item on the same page at the user interface, wherein the second selection popover includes names of the plurality of recipients; and allowing the user to select, in the second selection popover, one or more of the plurality of recipients to receive the second product item.

Implementations of the system may include one or more of the following. The computer-implemented method can further include receiving the single order comprising the first product item and the second product item after an activatable function at the user interface is activated by the user. The first selection popover and the second selection popover can include addresses of the plurality of recipients. The computer-implemented method can further include allowing the user to enter or select a product quantity for each of the multiple product items at the user interface. A first product quantity can be selected for the first product item, wherein a number of recipients are selected in the first selection popover. The number of selected recipients can be equal or more than the first product quantity; the computer-implemented method can further include assigning each of the recipients in the number of recipients to receive a single copy of the first product item. The number of selected recipients is less than the first product quantity; the computer-implemented method can further include: assigning a first recipient in the number of recipients to receive a predetermined copies of the first product item, wherein the predetermined copies is equal to the difference between the first product quantity and the number of recipient plus one; and assigning each of the rest recipients in the number of recipients to receive a single copy of the first product item. The page at the user interface is a web page in a web browser. The page at the user interface can be displayed in a mobile application. The user interface can be operated on a computer device that is connected to the computer network system via a wired computer network. The user interface can be operated on a mobile device that is connected to the computer network system via a wireless computer network. The computer-implemented method can further include manufacturing one or more of the multiple product items in response to the single order. The multiple product items can include at least one image product. The computer-implemented method can further include allowing the user, by the computer network system, to personalize the image product. The computer-implemented method can further include allowing the user to select payment method and shipping method at the user interface.

These and other aspects, their implementations and other features are described in detail in the drawings, the description and the claims.

### BRIEF DESCRIPTION OF THE DRAWINGS

FIG. 1 is a block diagram for a network-based system for producing personalized image products, image designs, or image projects compatible with the present invention.

FIG. 2 illustrates an exemplified user interface that summarizes product items in an order that a user is about to purchase over a computer network.

FIG. 3 illustrates the user interface that allows a user to enter recipient information.

FIG. 4 shows the user interface displaying a selection popover that allows user to assign recipients for a first product item in an order.

FIG. 5 shows the user interface displaying a selection popover that allows user to assign recipients for a second product item in the order.

FIG. 6 shows the user interface summarizes the product items to be shipped to each of the recipients in the order.

### DETAILED DESCRIPTION OF THE INVENTION

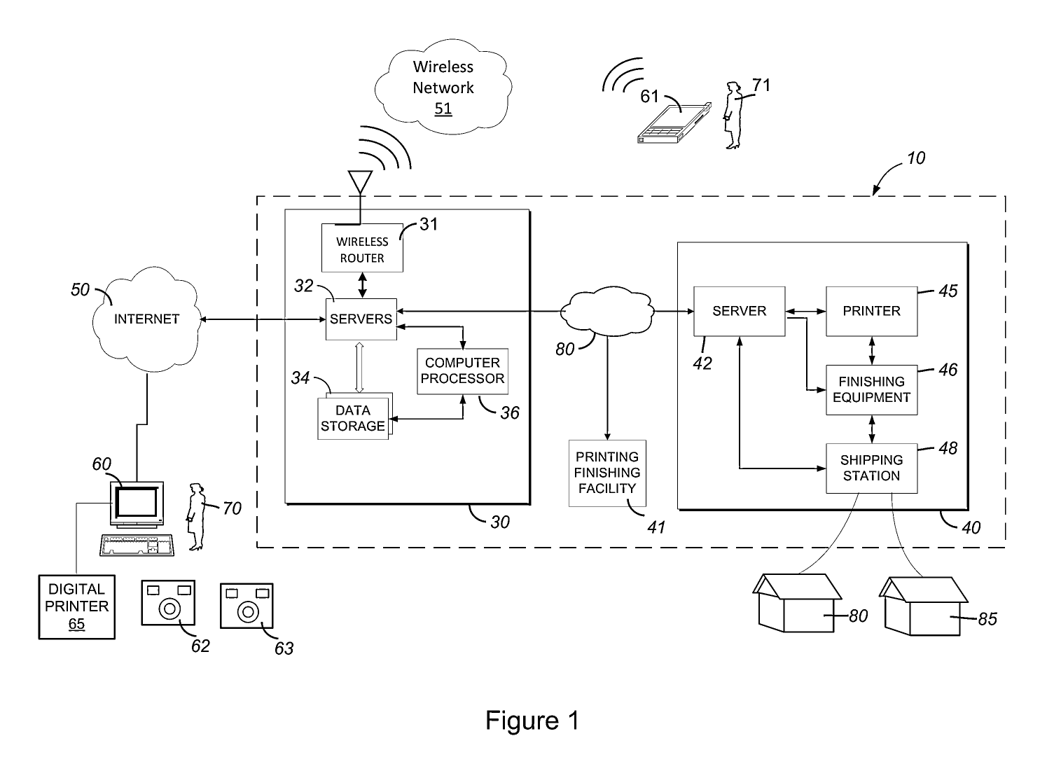

Referring to FIG. 1, a network-based imaging service system 10 can enable users 70, 71 to organize and share images via a wired network or a wireless network 51. The network-based imaging service system 10 is operated by an image service provider such as Shutterfly, Inc. Optionally, the network-based imaging service system 10 can also fulfill image products ordered by the users 70, 71. The network-based imaging service system 10 includes a data center 30, one or more product fulfillment centers 40, 41, and a computer network 80 that facilitates the communications between the data center 30 and the product fulfillment centers 40, 41.

The data center 30 includes one or more servers 32 for communicating with the users 70, 71, a data storage 34 for storing user data, image and design data, and product information, and computer processor(s) 36 for rendering images and product designs, organizing images, and processing orders. The user data can include account information, discount information, and order information associated with the user. A website can be powered by the servers 32 and can be accessed by the user 70 using a computer device 60 via the Internet 50, or by the user 71 using a wireless device 61 via the wireless network 51. The servers 32 can also support a mobile application to be downloaded onto wireless devices 61.

The network-based imaging service system 10 can provide products that require user participations in designs and personalization. Examples of these products include the personalized image products that incorporate photos provided by the users, the image service provider, or other sources. In the present disclosure, the term “personalized” refers to information that is specific to the recipient, the user, the gift product, and the occasion, which can include personalized content, personalized text messages, personalized images, and personalized designs that can be incorporated in the image products. The content of personalization can be provided by a user or selected by the user from a library of content provided by the service provider. The term “personalized information” can also be referred to as “individualized information” or “customized information”.

Personalized image products can include users' photos, personalized text, personalized designs, and content licensed from a third party. Examples of personalized image products may include photobooks, personalized greeting cards, photo stationeries, photo or image prints, photo posters, photo banners, photo playing cards, photo T-shirts, photo mugs, photo aprons, photo magnets, photo mouse pads, a photo phone case, a case for a tablet computer, photo key-chains, photo collectors, photo coasters, photo banners, or other types of photo gift or novelty item. The term photobook generally refers to as bound multi-page product that includes at least one image on a book page. Photobooks can include photo albums, scrapbooks, bound photo calendars, or photo snap books, etc. An image product can include a single page or multiple pages. Each page can include one or more images, text, and design elements. Some of the images may be laid out in an image collage.

The user 70 or her family may own multiple cameras 62, 63. The user 70 transfers images from cameras 62, 63 to the computer device 60. The user 70 can edit, organize images from the cameras 62, 63 on the computer device 60. The computer device 60 can be in many different forms: a personal computer, a laptop, or tablet computer, a mobile phone etc. The camera 62 can include an image capture device integrated in or connected with in the computer device 60. For example, laptop computers or computer monitors can include built-in camera for picture taking The user 70 can also print pictures using a printer 65 and make image products based on the images from the cameras 62, 63. Examples for the cameras 62, 63 include a digital camera, a camera phone, a video camera capable of taking motion and still images, a laptop computer, or a tablet computer.

Images in the cameras 62, 63 can be uploaded to the server 32 to allow the user 70 to organize and render images at the website, share the images with others, and design or order image product using the images from the cameras 62, 63. The wireless device 61 can include a mobile phone, a tablet computer, or a laptop computer, etc. The wireless device 61 can include a built-in camera (e.g. in the case of a camera phone). The pictures taken by the user 71 using the wireless device 61 can be uploaded to the data center 30. If users 70, 71 are members of a family or associated in a group (e.g. a soccer team), the images from the cameras 62, 63 and the mobile device 61 can be grouped together to be incorporated into an image product such as a photobook, or used in a blog page for an event such as a soccer game.

The users 70, 71 can order a physical product based on the design of the image product, which can be manufactured by the printing and finishing facilities 40 and 41. A recipient receives the physical product with messages from the users at locations 80, 85. The recipient can also receive a digital version of the design of the image product over the Internet 50 and/or a wireless network 51. For example, the recipient can receive, on her mobile phone, an electronic version of the greeting card signed by handwritten signatures from her family members.

The creation of personalized image products, however, can take considerable amount of time and effort. In some occasions, several people may want to contribute to a common image product. For example, a group of people may want or need to jointly sign their names, and write comments on a get-well card, a baby-shower card, a wedding-gift card. The group of people may be at different locations. In particular, it will be desirable to enable the group of people to quickly write their names and messages in the common image product using mobile devices.

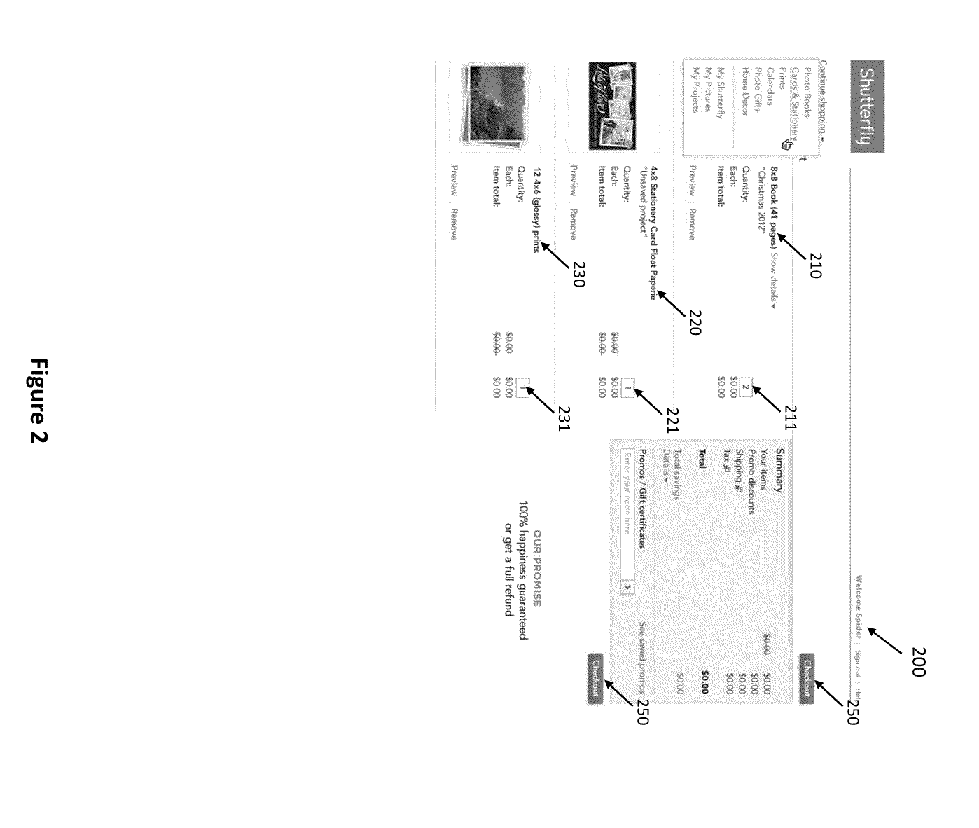

Referring to FIGS. 1 and 2, a user (e.g. 70 or 71) has created or selected multiple product items using a website or a mobile application enabled by the network-based imaging service system 10. An exemplified user interface 200 shows the product items 210, 220, 230 including two 8″×8″ photo books (210), one 4″×8″ stationery card float paperie (220), and a dozen of 4×6 glossy prints (230) in a single order. The user can enter or select quantities for the product items 210-230 using text boxes 211, 221, 231. The text boxes 211, 221, 231 can be implemented in many forms, for example by a number entering field, a selection list, or a pull-down list etc. The user can click or touch a “checkout” button 250 to order the product items 210-230 in a bundle. In response, the product items are placed in a shopping cart in the user's account ready to be ordered.

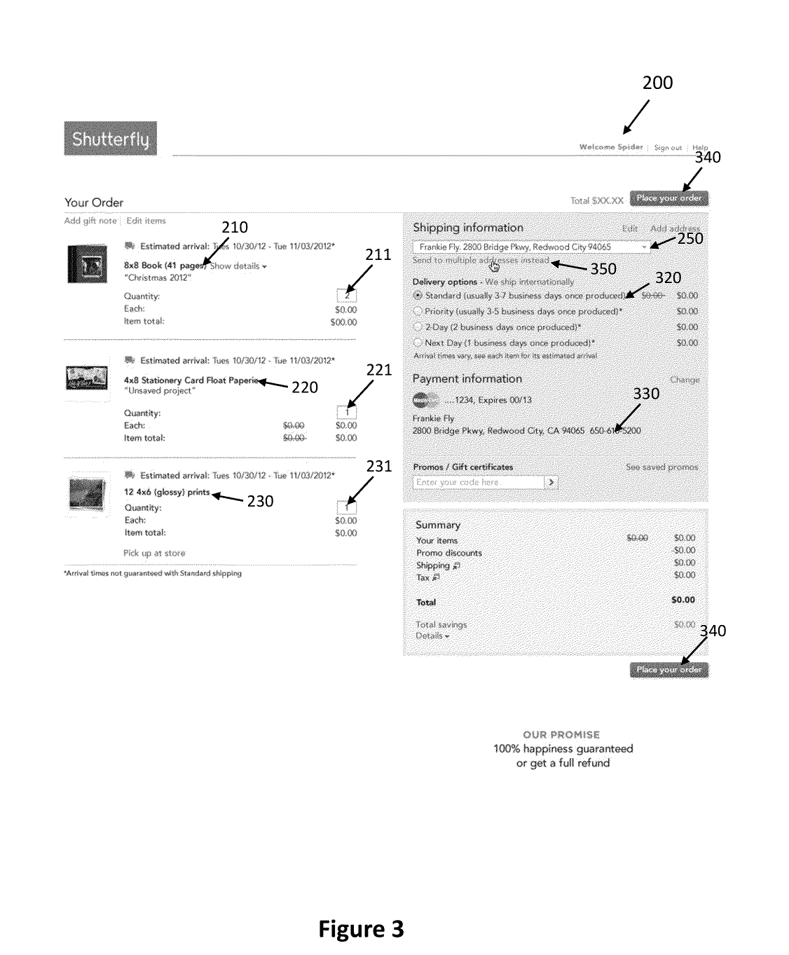

In response, in the next screen, referring to FIG. 3, the user can enter shipping address 310, shipping method 320, and payment information 330. The user can place the order by clicking button 340 if there is only a single recipient (e.g. “Frankie Fly”) for the order. The order to the single recipient includes the product items at their respectively pre-specified quantities. If the product items 210-230 are intended to be shipped to different recipients, the user can click the “Send to multiple addresses instead” link 350.

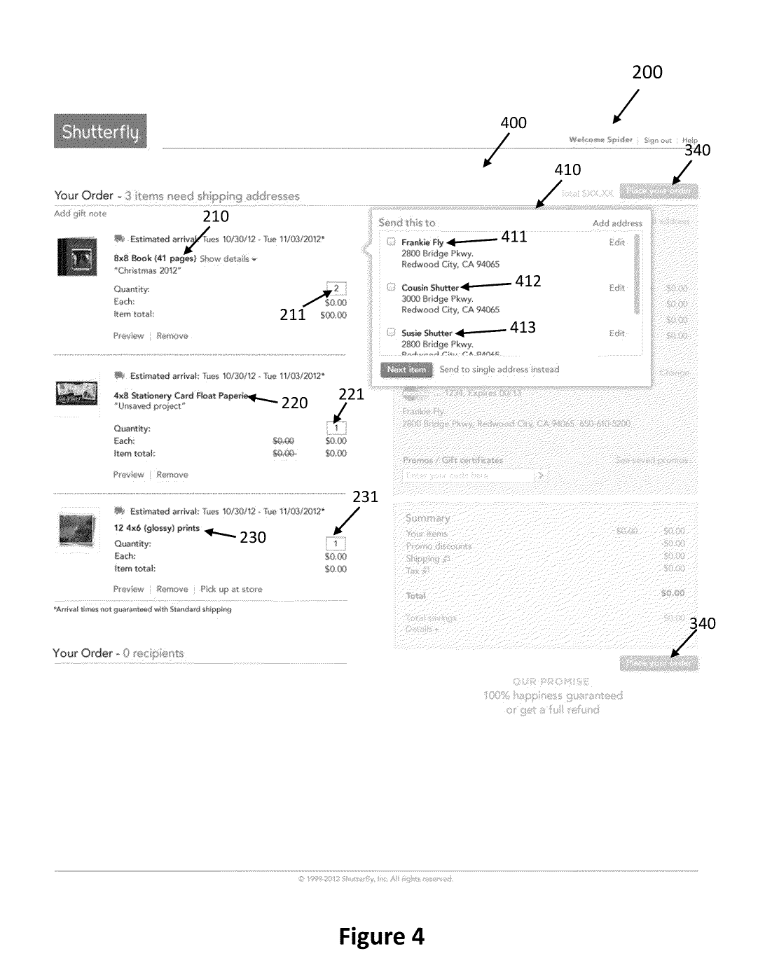

In response to the selection by the user to send the product items in the order to multiple recipients, a page 400 at the user interface 200, as shown in FIG. 4, allows the user to assign recipients for a first product item(s) 210 in a single order. The page 400 can be a web page in a web browser or a page in a mobile application.

An address selection popover 410 is displayed next to and pointing to the first product item(s) 210—the two 8″×8″ photo books. A list of recipients 411-413 and their respective addresses are displayed in the selection popover 410 for the user to pick. The user can pick one or more of the recipients 411-413. For example, “Frankie Fly” is selected to receive both 8″×8″ photo books (210) at that recipient's address. The “Place your order” button 340 is greyed out to prevent order being submitted before product items to be selected for the recipients.

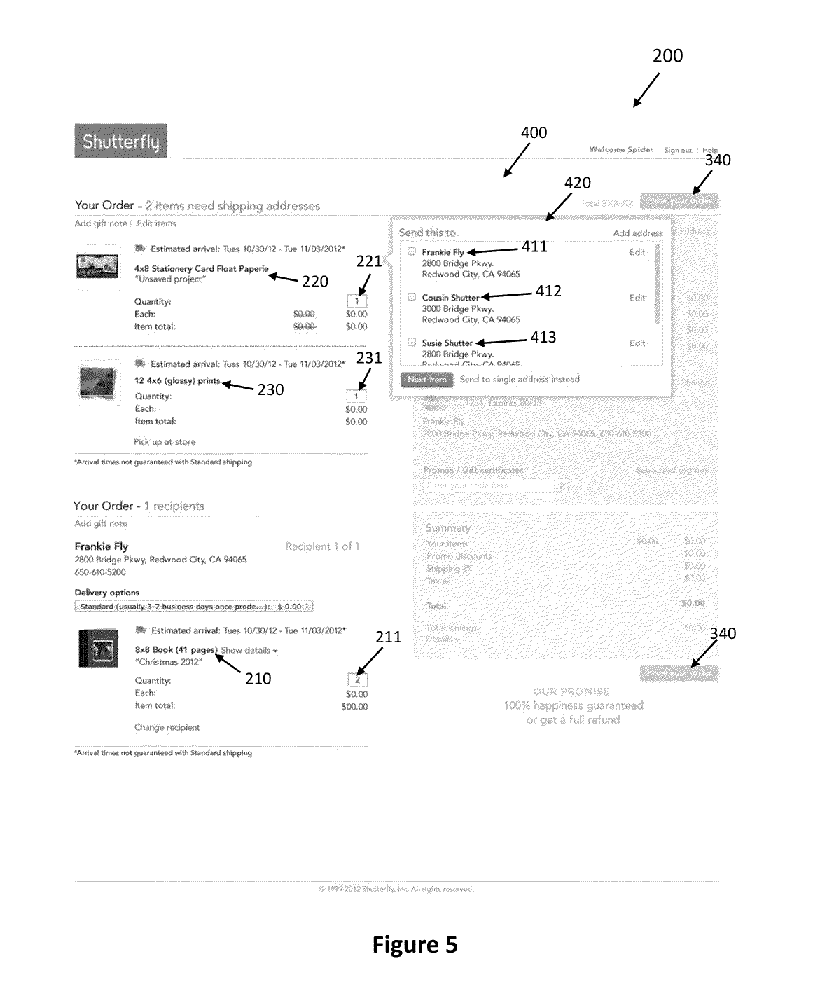

In the next screen, but staying in the same page 400, as shown in FIG. 5, the already-assigned product item(s) 210—the two 8″×8″ photo books are moved below in the assigned portion of the order indicating the recipient for those product item(s) 210. The remaining unassigned items (220, 230) move up, so that the next product item 220, the 4″×8″ stationery card float papery, is positioned next to the selection popover 420 for the user to assign one or more recipients 411-413.

The same process of recipient selection is repeated for the next product item(s) 230 the dozen of 4×6 glossy prints.

It should be noted that more than one recipient can be selected to receive a same product item. For example, referring to FIG. 4, both Frankie Fly 411 and Cousin Shutterfly 412, or even all three contacts 411-413 can all be selected in the selection popover to receive the 8″×8″ Book (210). The original quantity for the product item(s) in question can be used as a reference for assigning quantity of the product item to different recipients 411-413 based on the following logic:

If original quantity was less than the new total number of recipients, each new recipient receives 1 copy of that product item

If original quantity was the same as the new total number of recipients, each recipient receives 1 copy of that product item

If original quantity was greater than the new total number of recipients, each new recipient receives 1 copy of that item, except for the first recipient who gets the balance of the remaining copies of that product item. In other words, the first recipient is to receive a number of copies that is equal to the difference between the original product quantity and the number of recipient plus one. For example, if the original quantity for a product item is 5 and the customer selects three recipients for the product item, Recipient A's quantity=3; Recipient B's quantity=1; Recipient C's quantity=1.

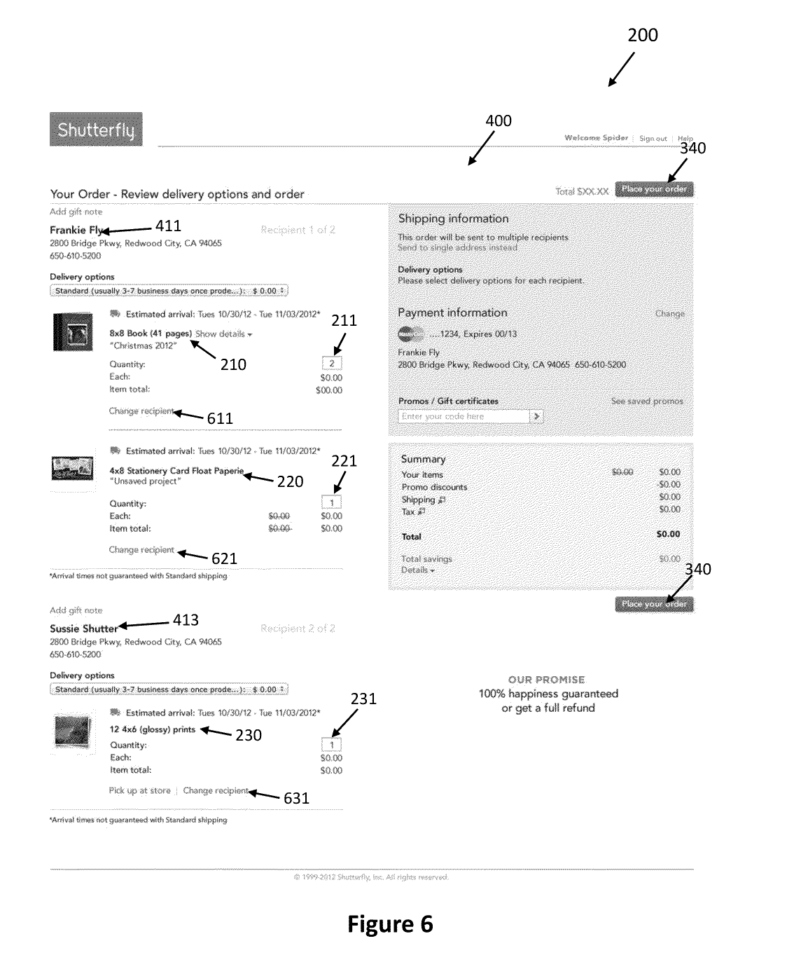

After all the product items in the order are assigned, the user interface 200, as shown in FIG. 6, the product items to be shipped to each of the recipients 411-413 in the order are summarized while still staying in the same page 400. The different recipients 411-413 can receive different, same, or partially different product items 210-230 in the order. If a user wants to change the recipient for a product item, she can click the “Change Recipient” links 611, 621, 631 under the product item. That product item will be shown in assigned state with a selection popover as shown in FIGS. 4 and 5. The user can select a different recipient.

It should be noted that as shown in FIGS. 4 and 5, the recipients are selected specific to a type of product item 210, 220, or 230, while in the order summary in FIG. 6, lists the product items 210-230 under each recipient. The recipient selection and order summary are summarized in a same page 400.

After verification, the user can enter promo code or gift certificate, if any, and place the order by clicking the “Place your order” button 340. The user can also customize the order shipment by set a target delivery time (for example, 2 days before a birthday or anniversary). The user can also enter and send personalized gift notes to different recipients. The items sent to different recipients 411-413 can also be via different shipping methods (Next Day, or 1^{st} Class, etc.).

In response, the image service provider can fulfill and manufacture the product items in the order and have the product items shipped to the specified recipients.

It should be understood that the presently disclosed systems and methods can be compatible with different devices or applications other than the examples described above. For example, the disclosed method is suitable for desktop, tablet computers, mobile phones and other types of network connectable computer devices.

1. A computer-implemented method for a user to order multiple product items for multiple recipients, comprising:
allowing a user, by a computer network system, to select multiple product items to be placed in a single order at a user interface, wherein the multiple product items comprises a first product item and a second product item;
displaying the multiple product items on a page at the user interface;
displaying a first selection popover next to the first product item on the same page at the user interface, wherein the first selection popover includes names of a plurality of recipients;
allowing the user to select, in the first selection popover, one or more of the plurality of recipients to receive the first product item;
displaying a second selection popover next to the second product item on the same page at the user interface, wherein the second selection popover includes names of the plurality of recipients; and
allowing the user to select, in the second selection popover, one or more of the plurality of recipients to receive the second product item.

2. The computer-implemented method of claim 1, further comprising:
receiving the single order comprising the first product item and the second product item after an activatable function at the user interface is activated by the user.

3. The computer-implemented method of claim 1, wherein the first selection popover and the second selection popover include addresses of the plurality of recipients.

4. The computer-implemented method of claim 1, further comprising:
allowing the user to enter or select a product quantity for each of the multiple product items at the user interface.

5. The computer-implemented method of claim 4, wherein a first product quantity is selected for the first product item, wherein a number of recipients are selected in the first selection popover.

6. The computer-implemented method of claim 5, wherein the number of selected recipients is equal or more than the first product quantity, the computer-implemented method further comprising:
assigning each of the recipients in the number of recipients to receive a single copy of the first product item.

7. The computer-implemented method of claim 5, wherein the number of selected recipients is less than the first product quantity, the computer-implemented method further comprising:
assigning a first recipient in the number of recipients to receive a predetermined copies of the first product item, wherein the predetermined copies is equal to the difference between the first product quantity and the number of recipient plus one; and
assigning each of the rest recipients in the number of recipients to receive a single copy of the first product item.

8. The computer-implemented method of claim 1, wherein the page at the user interface is a web page in a web browser.

9. The computer-implemented method of claim 1, wherein the page at the user interface is displayed in a mobile application.

10. The computer-implemented method of claim 1, wherein the user interface is operated on a computer device that is connected to the computer network system via a wired computer network.

11. The computer-implemented method of claim 1, wherein the user interface is operated on a mobile device that is connected to the computer network system via a wireless computer network.

12. The computer-implemented method of claim 1, further comprising:
manufacturing one or more of the multiple product items in response to the single order.

13. The computer-implemented method of claim 1, wherein the multiple product items comprise at least one image product.

14. The computer-implemented method of claim 13, further comprising:
allowing the user, by the computer network system, to personalize the image product.

15. The computer-implemented method of claim 13, further comprising:
allowing the user to select payment method and shipping method at the user interface.
